(19) United States
(12) Patent Application Publication
(10) Pub. No.: US 2013/0250452 A1
(43) Pub. Date: Sep. 26, 2013

(54) DISK STORAGE APPARATUS AND METHOD OF WRITING SERVO PATTERNS

(71) Applicant: Makoto ASAKURA, Tokyo (JP)

(72) Inventor: Makoto ASAKURA, Tokyo (JP)

(73) Assignee: Kabushiki Kaisha Toshiba, Tokyo (JP)

(21) Appl. No.: 13/553,416

(22) Filed: Jul. 19, 2012

(30) Foreign Application Priority Data
Mar. 22, 2012 (JP) 2012-065800

(51) Int. Cl. G11B 21/02

(52) U.S. Cl. 360/75; G9B/21.003

(57) ABSTRACT

According to one embodiment, a disk storage apparatus includes heads, disks and a controller. The controller performs a servo write control in order to write a plurality of radial servo patterns on each surface of the disk by using the spiral servo patterns. The servo controller positions the head above the spiral servo patterns by using first position information based on the spiral servo patterns. The position information generator generates second position information based on the radial servo patterns read by the head positioned above the spiral servo patterns. The processor corrects target position information for positioning the head based on the second position information by using the spiral servo patterns read by the head.

### CROSS-REFERENCE TO RELATED APPLICATIONS

This application is based upon and claims the benefit of priority from prior Japanese Patent Application No. 2012-065800, filed Mar. 22, 2012, the entire contents of which are incorporated herein by reference.

### FIELD

Embodiments described herein relate generally to a disk storage apparatus and a method for writing servo patterns.

### BACKGROUND

Disk drives, a representative example of which is a hard disk drive, have a disk having radial servo patterns (product servo patterns) recorded at the timing of shipping the disk drives. The radial servo patterns are servo patterns that is used for controlling the positioning of a head (that is, for performing servo control).

In recent years, the self-servo write method is performed, writing the radial servo patterns on the disk incorporated in a disk drive before the disk drive is shipped. In this case, the disk drive uses a plurality of spiral servo patterns (multi-spiral servo patterns) already written on the disk, thereby controlling the positioning of the head and ultimately writing the radial servo patterns on the disk.

In the self-servo write method of writing radial servo patterns (product servo patterns) on the disk by using multi-spiral servo patterns, the track pitch varies, depending on the signal quality of the multi-spiral servo patterns. Further, the track pitch varies due to the vibration of the rotating shaft of the spindle motor that rotates the disk, in the bank write operation of writing the radial servo patterns on the disk surfaces by using a plurality of heads at the same time. The variation in the track pitch due to these causes may decrease the accuracy of writing the radial servo patterns.

### BRIEF DESCRIPTION OF THE DRAWINGS

FIG. 1 is a block diagram for explaining the configuration of a servo controller according to an embodiment;

FIG. 2 is a block diagram showing the major components of a disk drive according to the embodiment;

FIG. 3 is a diagram showing the state in which an MSP pattern and a SSW pattern, both according to the embodiment, are recorded on a disk;

FIG. 4 is a diagram showing an example of MSP pattern according to the embodiment;

FIG. 5 is a diagram for explaining the configuration of the MSP pattern according to the embodiment;

FIG. 6 is a diagram showing an example of a simulation result of a head positioning control according to the embodiment;

FIG. 7 is a diagram for explaining a positioning error made when one head is switched to another in the embodiment;

FIG. 8 is a flowchart for explaining an SSW process according to the embodiment; and

FIG. 9 is a flowchart for explaining a POS-SSW detection process according to the embodiment.

### DETAILED DESCRIPTION

Various embodiments will be described hereinafter with reference to the accompanying drawings.

In general, according to one embodiment, a disk storage apparatus includes heads, disks and a controller. Each head is configured to read and write data. Each disk has a plurality of spiral servo patterns recorded on one surface. The controller is configured to perform a servo write control in order to write a plurality of radial servo patterns on each surface of the disk by using the spiral servo patterns. The controller includes a servo controller, a position information generator, and a processor. The servo controller is configured to position the head above the spiral servo patterns by using first position information based on the spiral servo patterns. The position information generator is configured to generate second position information based on the radial servo patterns read by the head positioned above the spiral servo patterns. The processor is configured to correct target position information for positioning the head based on the second position information by using the spiral servo patterns read by the head.

[Configurations of the Disk Drive and Servo Controller]

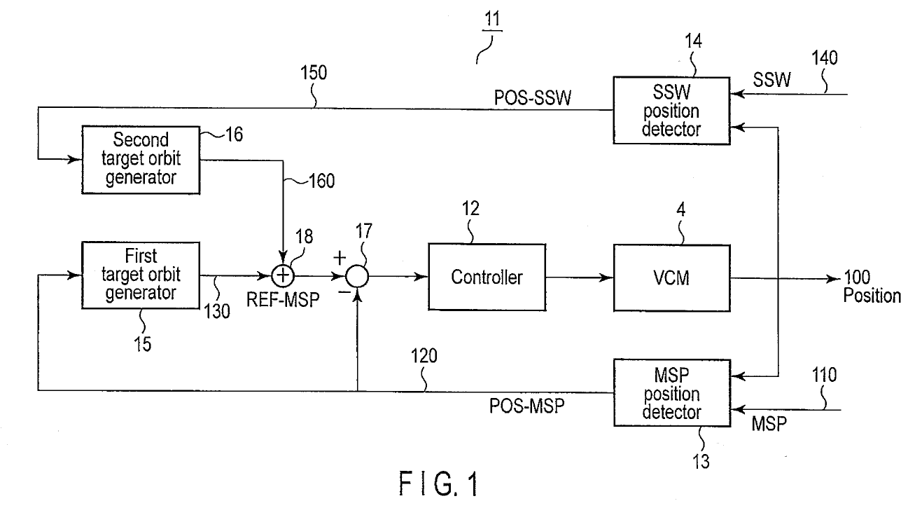

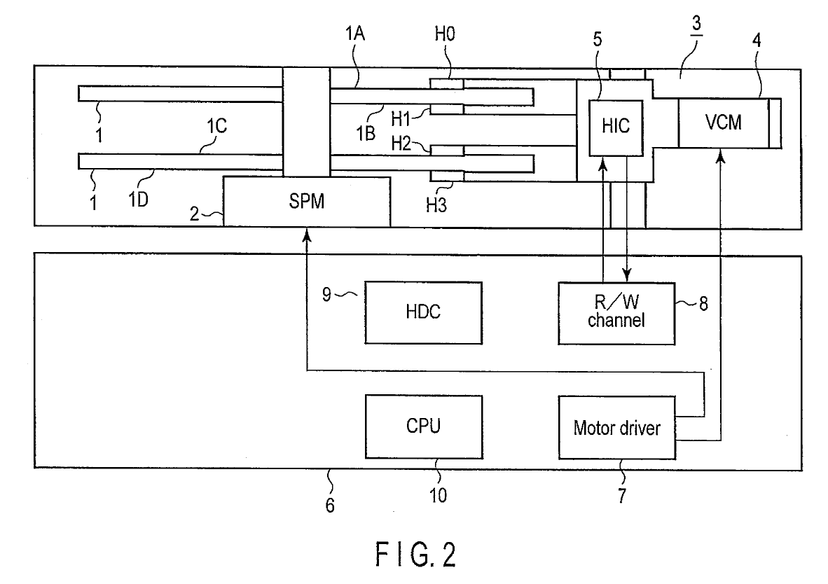

FIG. 1 is a block diagram showing the configuration of the servo controller 11 that is incorporated in a disk drive according to the embodiment. FIG. 2 is a block diagram showing the major components of the disk drive. The disk drive according to the embodiment has a self-servo writing (SSW) function that is implemented, mainly by a microprocessor (CPU) 10.

As shown in FIG. 2, the disk drive has a plurality of disks 1 (two disks in the embodiment), a spindle motor (SPM) 2, an actuator 3, a plurality of heads (four heads H0 to H3 in the embodiment). The SPM 2 rotates each disk 1 secured to a shaft. The actuator 3 holds heads H0 to H3 and is rotated by the voice coil motor (VCM) 4. The actuator 3 moves heads H0 to H3 at the same time radially with respect to the disks 1. In the embodiment, the two disks have two disk surfaces each. More specifically, one disk has disk surfaces 1A and 1B, and the other disk has disk surfaces 1C and 1D. On disk surface 1B of the disk 1, a plurality of servo spiral patterns (multi-servo spiral patterns, hereinafter referred to as “MSPS” in some cases), which will be described later. Each of heads H0 to H3 includes a read head element and a write head element. The read head element is configured to read data from a disk surface, and the write head element is configured to write data on a disk surface. In this embodiment, head H1 reads MSPs from disk surface 1B, whereby an SSW process is performed.

The disk drive further includes, components mounted on a circuit board 6, a motor driver 7, a read/write (R/W) channel 8, a disk controller (HDC) 9, and a microprocessor (CPU) 10.

The motor driver 7 includes an SPM driver configured to supply a drive current to the SPM 2, and a VCM driver configured to supply a drive current to the VCM 4. The actuator 3 holds a head amplifier (head integrated circuit, or HIC) 5. The HIC 5 is connected to heads H0 to H3 and configured to transmit read/write signals to heads H0 to H3.

The R/W channel 8 processes the read signals transmitted from the HIC 5 and generates MSPs or radial servo patterns (product servo patterns), and reproduces servo patterns. The R/W channel 8 also processes the read signals transmitted from the HIC 5, too, and reproduces user data. Further, the R/W channel 8 processes the write signals for writing radial servo patterns, and converts the servo patterns to write signals. The write signals are transmitted to the HIC 5. Still further, the R/W channel 8 receives the user data transferred from the HDC 9 and converts the user data to write signals. The write signals are transmitted to the HIC 5.

The HDC 9 is the interface provided for the disk drive and a host (not shown), and is configured to control the transfer of user data between the disk drive and the host. The CPU 10 cooperates with the HDC 9, controlling the reading and writing of the user data, and also performs the SSW process according to the embodiment. The CPU 10 is the main component of the servo controller 11 that performs the position control (servo control) of heads H0 to H3, in preparation for the SSW process.

Hereinafter, the radial servo patterns (product servo patterns) written on disk surfaces 1A to 1D in the SSW process will be referred to as “SSW patterns.”

The configuration of the servo controller 11 will be described with reference to FIG. 1.

As shown in FIG. 1, the servo controller 11 includes a controller 12, an MSP position detector 13, an SSW position detector 14, a first target orbit generator 15, and a second target orbit generator 16. The controller 12 performs a feedback control (to be described later), thereby controlling the positioning of head H1 so that head H1 may read an MSP 110 from disk surface 1B.

The MSP position detector 13 detects the position head H1 takes on the MSP, from the MSP 110 read by head H1, and generates position data (POS-MSP) 120 that represents the position of head H1. The first target orbit generator 15 generates first target position data 130 that represents the target position (for example, target track) for head H1. More precisely, the first target orbit generator 15 generates the first target position data 130 from the POS-MSP 120 output from the first target orbit generator 15, so that head H1 may move always in a smooth and parallel track even if its radial position with respect to the disk changes.

The controller 12 first calculates a control command value that makes the POS-MSP 120 agree to the target position REF-MSP available at present, and then outputs a current-command equivalent value to the VCM driver incorporated in the motor driver 7. Note that the target position REF-MSP available at present is the first target position data 130 in a feedback system that does not have the second target orbit generator 16 (later described). The controller 12 calculates a control command value from the deviation of POS-MSP with respect to REF-MSP, which a deviation meter 17 has output. In accordance with the control command value thus calculated, the VCM driver supplies the VCM 4 with a drive current (i.e., excitation current for the coil of the VCM 4).

So controlled by the controller 12, the VCM 4 rotates the head stuck of the actuator 3 around a pivot, and changes the radial position with respect to the disk that head H1 takes. This feedback control keeps positioning head H1 at the target position REF-MSP that changes from time to time.

In this embodiment, the SSW position detector 14 and the second target orbit generator 16 constitute a target position correction processor that corrects the target position at an MSP. The SSW position detector 14 detects the positions of heads H0 to H3 (i.e., positional deviations from the track centerline) from the SSW patterns written on disk surfaces 1A to 1D. The SSW position detector 14 then outputs position data 150 (POS-SSW) that represents these positions detected. That is, the SSW position detector 14 generates position data 150 (POS-SSW) from the SSW pattern 140 read by one of heads H0 to H3, which has been selected. The SSW position detector 14 has a valid/invalid flag; it does not operate at all times, but only when the target position must be corrected. More specifically, the SSW position detector 14 does not operate during the seek operation of heads H0 to H3 or during the SSW process of writing SSW patterns.

The second target orbit generator 16 generates second target position data 160 to correct the target position REF-MSP at the MSP, from the position data (POS-SSW) 150 output from the SSW position detector 14, as will be explained later. An adder 18 adds the second target position data 160 to the first target position data 130, outputting corrected target position REF-MSP.

[SSW Process]

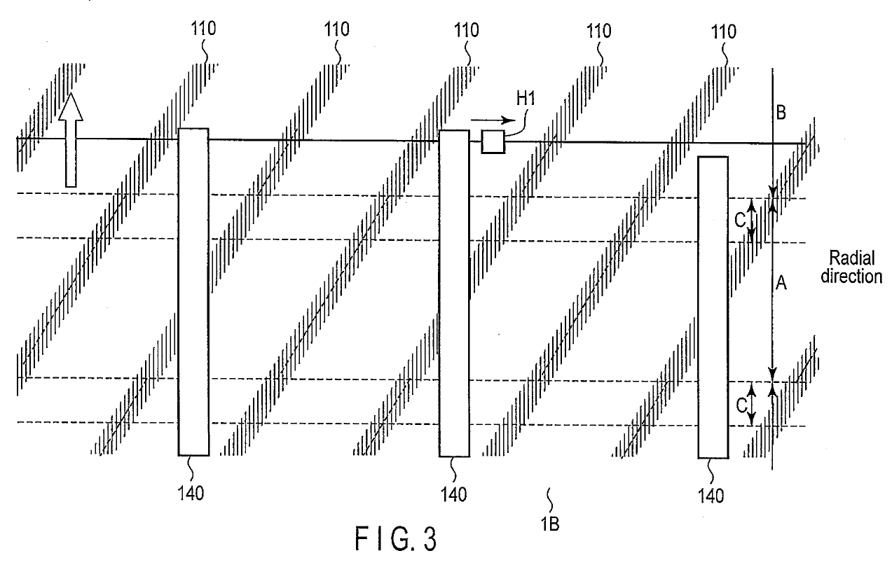

The SSW process according to this embodiment will be explained with reference to FIG. 3 to FIG. 9.

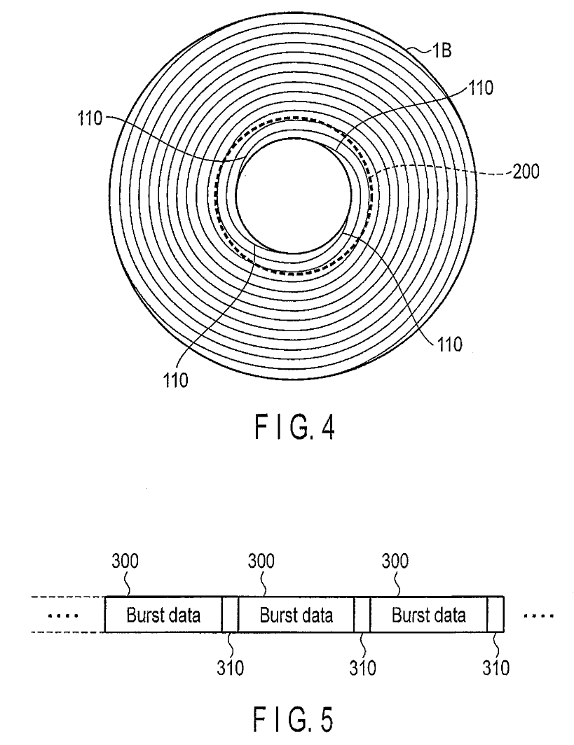

The SSW process according to this embodiment is performed in the disk drive just assembled as shown in FIG. 2 in the manufacturer's factory. As shown in FIG. 4, MSPs 110 are recorded on disk surface 1B of the first disk 1. No patterns are recorded on disk surface 1B of the first disk 1 or on disk surfaces 1C and 1D of the second disk 1. Thus, disk surfaces 1B, 1C and 1D are blank surfaces.

As shown also in FIG. 4, radial servo patterns called “seed patterns 200” are overwritten in the innermost circumferential part of disk surface 1B. The seed patterns 200 are used to position head H1 in the initial phase of the SSW process, in order to make the disk drive learn the corrected value for the target position (i.e., target track). The MSPs 110 are 2×N spiral patterns, where N is the number of radial servo patterns (SSW patterns) 140. As shown in FIG. 5, each MSP is composed of sync signals (SYNC) 310 and burst signals 300 that are alternately arranged.

As shown in FIG. 3, the write head element of head H1 writes radial servo patterns (SSW patterns) 140 in the SSW process, while the servo controller 11 keeps positioning head H1 at the target position (REF-MSP) on one MSP 110. In this case, the disk drive performs a bank write operation. That is, the write signals associated with the radial servo patterns 140 are simultaneously transmitted to heads H0 to H3 through the HIC 5, whereby data is written on disk surfaces 1A to 1D at the same time.

The radial servo patterns 140 are patterns, each representing the address of one servo track. They are recorded from the innermost circumference to the outermost circumference at a pitch of, for example, half a track. In this case, the servo controller 11 sequentially changes the tracking position of head H1. The servo track is a track formed by jointing the sectors of servo patterns 140 together in the circumferential direction of the disk. The disk drive eventually forms SSW patterns 140 spaced apart at regular intervals in the circumferential direction, each including a preamble, a servo mark, a Grey code, and a servo burst signal. Note that a postcode or repeatable runout (RRO) to be incorporated into the final product pattern is not recorded in the SSW process.

In FIG. 3, the broken line drawn in each respective MSP 110 pattern indicates the first servo gate timing at which to make head H1 track the MSP. Head H1 moves from left to right while it is tracking any MSP 110. When an SSW patterns 140 is formed to some extent in the SSW process, the MSP 110 overlaps the SSW pattern 140 and is therefore written over the SSW pattern 140. This is why the MSPs 110 are provided twice as many as the number N of servo patterns 140 finally formed. This ensures the forming of MPSs 110 on concentric circles ensures and equidistantly spaced from one another. In the embodiment, the SSW process proceeds, alternately selecting the even-numbered (even) MSPs 110 and the odd-numbered (odd) MSPs 110.

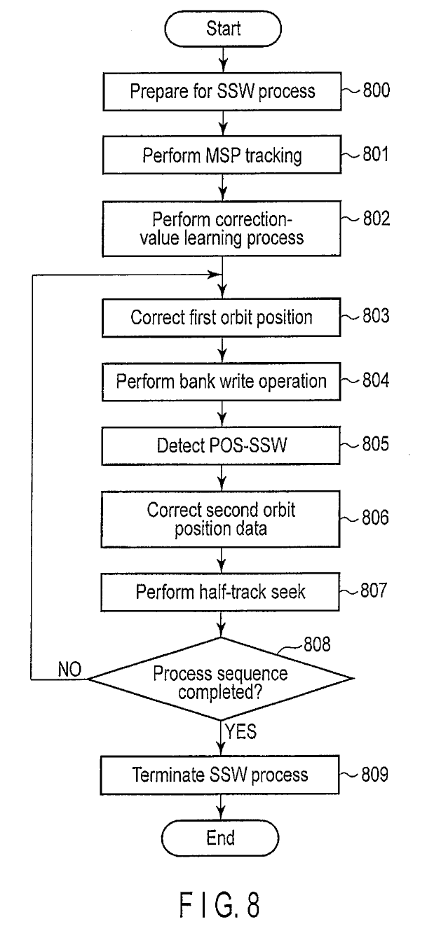

The sequence of the SSW process according to the embodiment will be explained with reference to the flowchart of FIG. 8.

First, the CPU 10 makes preparation for the SSW process (Block 800). That is, the CPU 10 causes the motor driver 7 to drive the VCM 4, which drives the actuator 3. So driven, the actuator 3 moves heads H0 to H3 over the disks 1, until heads H0 to H3 reach the innermost circumferences of the disks 1. Head H1 searches for a seed pattern 200 and finally tracks the seed pattern 200. The preparation for the SSW process includes the learning of a corrected value for the timing error of any MSP 110 and the adjustment of the flying heights of all heads H0 to H3 used to perform the bank write operation.

Next, after head H1 has tracked the seed pattern 200, the servo controller 11 searches for an MSP 110 to make head H1 track the MSP 110 (Block 801). At this point, the servo controller 11 uses the corrected value learned, adjusting the servo gate timing of the MSP 110 so that the tracking locus of head H1 may almost parallel to the tracking locus in which head H1 has tracked the MSP 110.

While the MSP 110 is being tracked, the target position may be adjusted radially with respect to the disk by shifting the servo gate timing of the MSP 110, not by adding a target correction value to the deviation of MSP detection. In the embodiment, the servo gate timing is shifted to adjust the target position in the initial phase of tracking.

Then, the servo controller 11 performs a process of learning the initial correction value for correcting the target position, by using the second target position data 160 (described later) (Block 802). This process is performed in order to make the head locus at the MPS tracking become parallel to the head locus at the tracking of the seed pattern 200. That is, the SSW position detector 14 is used, learning the initial correction value, as will be explained later. This target value correction by the process of learning the initial correction value is achieved also at the servo gate timing. Nonetheless, like the ordinary servo process, the process of learning the initial correction value may be performed to acquire a target value that should be added to the deviation of MSP detection.

The servo controller 11 then generates a second servo gate different from the first servo gate for detecting the MSP, at the time head H1 passes the seed pattern 200, in order to detect the positional deviation head H1 undergoes while tracking the seed pattern 200. More precisely, the servo controller 11 detects the servo mark of the seed pattern 200 at the timing of the second servo gate, thereby finding the positional deviation head H1 undergoes while tracking the MSP. The servo mark of the seed pattern 200 is detected by the R/W channel 8 from the seed pattern 200 read by head H1. In the process of learning the initial correction value, the positional deviation is acquired through the sequential discrete Fourier transform (DFT), thereby updating the target correction value for low-order sync components. The target correction value for low-order sync components is updated until the low-order sync component of the positional deviation with respect to the seed pattern 200 becomes equal to or smaller than the tolerance. The target correction value final for the sync component is the initial correction value for correcting the target position, by using the second target position data 160. The process of learning the initial correction value is performed in the embodiment. Nonetheless, this process may not be performed if the corrected value learned is used, successfully correcting the MSP timing error.

The servo controller 11 performs the process of correcting the first target position while the MSP is being tracked (Block 803). This process is performed in order to suppress a discontinuous variation of the track pitch at the time of switching the MSP, which will be described later. Therefore, the servo controller 11 skips the process of correcting the first target position in the initial phase of the SSW process.

The CPU 10 causes all heads H0 to H3 to perform the bank write operation while head H1 is tracking the MSP 110 (Block 804). SSW patterns 140 for one track are thereby recorded at the same time on each of disk surfaces 1A to 1D.

Next, the servo controller 11 causes the SSW position detector 14 to detect the position data (POS-SSW) 150 (Block 805), and causes the second target orbit generator 16 to correct the second target position data 160 (Block 806). In the initial phase of the SSW process, however, the servo controller 11 does not cause the SSW position detector 14 or the second target orbit generator 16 to so operate, because the SSW patterns 140 have not fully formed yet.

The servo controller 11 then shifts the position of MSP servo gate timing by a half-track distance, thereby moving head H1 toward the outermost circumference by the distance of half a track (Block 807). The CPU 10 repeatedly operates until this sequence of process is completed, whereby SSW patterns 140 are written on disk surfaces 1A to 1D of the disks 1 (Block 808). That is, the CPU 10 repeats the SSW process up to the outermost circumferences of the disks 1, writing SSW patterns 140 for a prescribed number of servo tracks. When the SSW patterns 140 are all written, the CPU 10 terminates the SSW process (Block 809).

The servo gate timing for both the even MSPs 110 and odd MSPS 110 are learned beforehand, in the initial phase of the process of learning the initial correction value (Block 802). The locus of head H1 is thereby made parallel when the MSP is tracked before and after the MSP 110 is switched. This is because the even MSPs 110 have been formed at a time and the odd MSPs 110 at a different time, before in the servo pattern writing process, and the even and odd MSPs 110 cannot be equidistantly spaced from one another.

The process of learning the initial correction value cannot make head H1 move in a parallel locus before and after the MSP 110 is switched. Hence, as shown in FIG. 3, target-position updating regions C for correcting the first target position (i.e., target track) are provided on each disk surface, each before the point where a region A for even-MSP tracking is switched to a region B for odd-MSP tracking, or vice versa. In these regions C, neither an even MSP nor an odd MSP is written over the SSW pattern. Thanks to the target-position updating regions C, the positional deviation of any MSP other than the MSP 110 being tracked at present can be detected.

The servo controller 11 uses the positional deviation data (in any target-position updating region C) not utilized in the MSP tracking process, thereby performing the process of correcting the first target position (Block 803). This can make the locus of head H1 parallel before and after an even MSP 110 is switched to an odd MSP 110, or vice versa.

Even if the process of correcting the first target position is performed, a servo-defective track may be formed at any position where the even MSP 110 is switched to an odd MSP 110, when the SSW patterns 140 are written. In other words, many data track defects may occur due to a read/write offset, i.e., positional displacement between the read head element and write head element of head H1, resulting from an insufficient parallelism of radial regions A and B both shown in FIG. 3. In view of this, the SSW patterns 140 already written are monitored while head H1 is tracking the MSP during the SSW process, thereby to enhance the parallelism of radial regions A and B. This is the process in which the SSW position detector 14 detects the POS-SSW 150 and the position data (POS-SSW) 150 correcting the second target position (target track) and the second target orbit generator 16 corrects the second target position (target track).

(POS-SSW Detection Process)

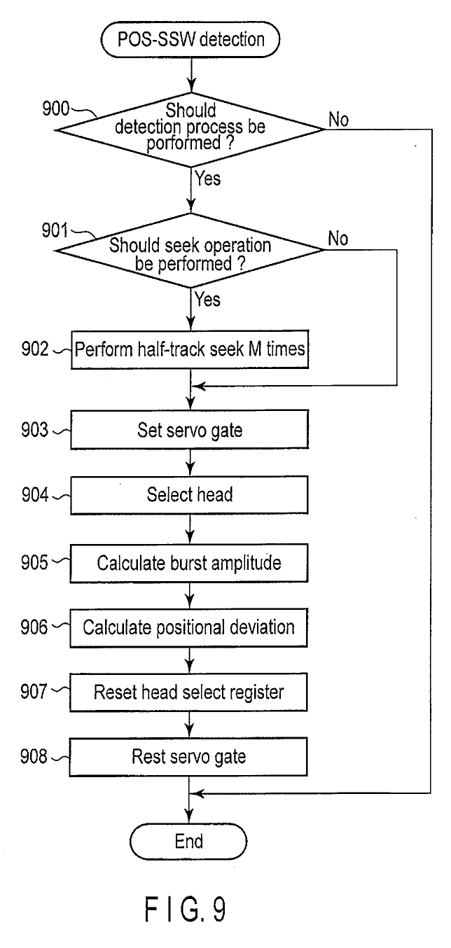

The POS-SSW detection process (Block 805 in FIG. 8), which the SSW position detector 14 performs, will be explained with reference to the flowchart of FIG. 9.

The servo controller 11 determines whether the POS-SSW detection process should be performed or not (Block 900). Immediately after the even MSP 110 has been switched to the odd MSP 110, or vice versa, as described above, the POS-SSW detecting that process determines that the POS-SSW detection process need not be performed, and goes to the next step, determining whether the seek operation should be performed or not (Block 901).

In the process of determining whether the seek operation should be performed, the servo controller 11 determines, from the above-mentioned read/write offset, that the seek operation needs to be performed because of the difference between the read head element and the write head element in terms of the radial position. If the SSW process is performed at an outer circumferential part of the disk, the SSW pattern 140 can be reproduced while head H1 remains tracking the MSP. The SSW position detector 14 can therefore detect the position data (POS-SSW) 150.

At an inner circumferential part of the disk, the SSW pattern 140 has not yet been completely formed. Head H1 must therefore seek the region where the SSW pattern 140 is completely formed. The seek distance head H1 should move has been set for each zone of the SSW pattern. The seek distance head H1 should be moved is determine from the data about the zone over which head H1 is now located. This seek distance is equivalent to the read/write offset, not so long, and falls within the width of region C that can be tracked in both the even MSP 110 and the odd MSP 110 (FIG. 3).

If the seek operation is necessary, the servo controller 11 repeats the half-track motion M times, without switching the even MSP 110 to the odd MSP 110, or vice versa, thereby moving head H1 to the prescribed position (Block 902). Then, the servo controller 11 sets the second servo gate in order to detect the SSW pattern 140 (Block 903). In this case, the position at which to start the second servo gate with respect to the first second servo gate varies in accordance with the radial position head H1 now takes or with the servo sector over which head H1 now lies. Therefore, the servo controller 11 calculates the position at which to start the second servo gate for each servo sector, setting appropriate intervals at which to detect SSW patterns 140.

For head H1 tracking the MSP, all heads H0 to H3 have written the SSW patterns 140. Hence, the CPU 10 determines, beforehand, which SSW pattern should be detected. Then, the CPU 10 changes the content of the head select register incorporated in the HIC 5 when head H1 is selected (Block 904). The reproduced signal that the HIC 5 outputs when head H1 is selected is switched to the signal reproduced from the SSW pattern 140 recorded on a disk surface over which the selected head (i.e., head H1) lies.

The CPU 10 detects a servo mark from the second servo gate, by utilizing the servo reproducing function of the R/W channel 8. The CPU 10 generates a plurality of burst gates (BGATEs) on the basis of the position where the servo mark has been detected, and sets the amplitude of each BGATE in a register incorporated in the R/W channel 8 (Block 905). The CPU 10 monitors the amplitudes of the BGATEs in the register, calculating the positional deviation from the burst center (Block 906).

The CUP 10 finally resets the second servo gate changed (Block 907), and also the head select register (Block 908). As a result, the reproduced signal coming from the HIC 5 becomes a signal head H1 has read from disk surface 1B of the disk 1. The MSP position detector 13 can therefore detects the MSP positional deviation at the next first servo gate.

Then, the servo controller 11 goes from the process of detecting the POS-SSW 150 to the process of correcting the second target position (Block 806), which performed by the second target orbit generator 16. More precisely, the servo controller 11 generates second target position data 160 for correcting the target position REF-MSP on the MSP 110, from the position data (POS-SSW) 150 output from the above-mentioned SSW position detector 14. The adder 18 adds the second target position data 160 to the first target position data 130, outputting corrected target position REF-MSP.

The second target orbit generator 16 generates the second target position data 160, by one of the three methods described below.

The first method generates target rotation-sync compensation data for suppressing low-order sync components. In the first method, the second target orbit generator 16 infers the DFT coefficients of all low-order sync components, but the first-order sync component, from the position data (POS-SSW) 150, and corrects the DFT coefficients by using the sensitivity function of the VCM control loop (i.e., feedback system shown in FIG. 1). Further, the second target orbit generator 16 synthesizes the low-order components in accordance with the DFT coefficients so corrected, thereby generating compensated track data. The process of generating the compensated track data is valid, basically when the SSW process proceeds at outer circumferential parts of the disk.

The second method generates track correction data for compensating the parallelism difference between the two tracks head H1 traces, respectively before and after the MSP switching. The first target orbit generator 15 also generates correction data for a similar purpose. In the second method, the second target orbit generator 16 generates track correction data that reduces the parallelism difference made before and after the MSP switching to be less than the correction data generated by the first target orbit generator 15 does.

Thus, the second target position data 160 is updated immediately after the MSP has been switched. More specifically, the SSW position detector 14 detects the POS-SSW 150 while the first target orbit generator 15 is correcting the track. The second target orbit generator 16 generates second target position data 160 that serves to reduce the deviation change of the POS-SSW 150.

The second target orbit generator 16 may perform a repeated learning process to generate the second target position data 160. In this embodiment, the second target orbit generator 16 generates the data as a waveform defined by synthesizing sync components in a plurality of DFT processes, and does not suppress the high-order components. This is because the SSW pattern changes when recorded in the high-order SSW process. Only the low-order sync components are therefore suppressed, not influenced by such a change of the SSW pattern. As another method, the parallelism difference made before and after before and after the MSP switching may be used as average value for a plurality of tracks.

In this embodiment, the deviation of the POS-SSW 150 is measured only immediately after the pattern has been switched, on the assumption that the deviation change of the POS-SSW 150 has already been adjusted to a sufficiently small value before the MSP switching. The data representing the deviation of the POS-SSW 150 measured before the MSP switching may be extended in a memory beforehand and may then be corrected in accordance with the difference between it and the POS-SSW 150 measured after the MSP switching. The correction value is acquired by actually operating head H1 in this embodiment. Instead, the correction value may be generated from the average for all heads H0 to H3. The third method generates, as second target position data 160, a direct current (DC) correction value for suppressing the changes in the track pitch. The target track is corrected in the third method, in order to correct a track pitch change that may occur for a long period in the written SSW pattern during the SSW process. That is, the correction value is always a constant DC correction value, irrespective of the position of the servo sector. This method of correcting the target track is designed to be most effective in the SSW process at the intermediate circumferential part of the disk, because the track pitch tends to increase toward the outermost circumferential part of the disk.

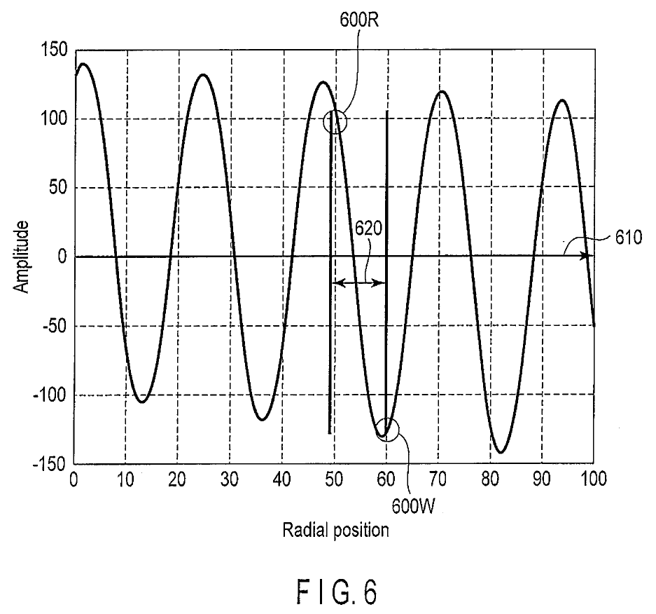

FIG. 6 is a diagram showing the results of simulating the positional error of a head at the outermost circumferential part of the disk. More precisely, FIG. 6 shows how the DC value changes as the head moves radially with respect to the disk. The simulation results of FIG. 6 represent the DC variation in an SSW pattern which head H0 has written. Deviation 620 shown in FIG. 6 indicates the offset between the read head element 600R and write head element 600W of head H0.

As the head keeps tracking the MSP, the DC value gradually acquires an almost constant value 610 at the MSP tracking surface. At the position where the SSW is performed on the disk surface remotest from the head at the tracking, however, the DC value tends to change in the form of a sinusoidal wave having an amplitude and cycle, both almost constant, because of the relation between the axis swing the SPM 2 and the height of the head.

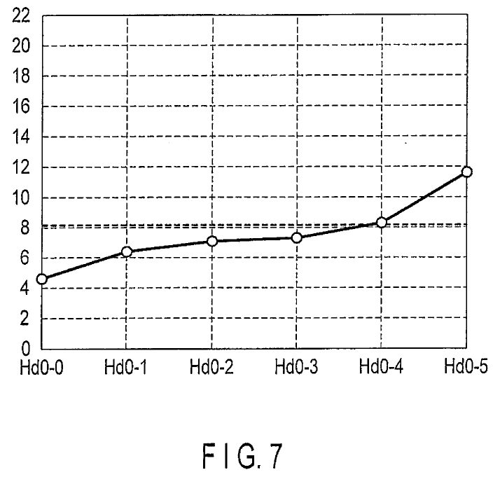

FIG. 7 shows the shifts resulting from the positional errors of the head, which have been actually measured in a disk drive having six heads H0 to H5. To be more specific, FIG. 7 shows the head positioning precision (i.e., positional precision) observed when the head was switched from head H0 to head H1. In FIG. 7, the positioning precision is plotted on the vertical axis. As can be seen from FIG. 7, the DC variation gradually increases in proportion to the tracking error of the head.

In this embodiment, the second target orbit generator 16 finds the average DC component for all heads at respective tracks, from the POS-SSW 150 accumulated at the positions the respective heads assume at the present MSPs. Further, since the DC value can be approximated to the sinusoidal wave representing prescribed track seek cycles, the DFT coefficient is calculated for the DC value, and a DC correction value at the head position over the present MSP is predicted from the OFT coefficient.

In this case, the DC correction value is predicted from the average for all heads. This is because the DC shift differs in amplitude, from head to head, as can be seen from FIG. 7. That is, the DC correction value is predicted from the average DC value so that the maximum pitch change may finally fall within the tolerance in the SSW process. In other words, the track pitch changes for all heads are smaller than the tolerant value even if the track pitch greatly changes for head H1 now tracking the MSP.

In the third method explained above, the final DC correction value is predicted, for the reason that will be explained below with reference to FIG. 6.

When the SSW process is performed at any head that is tracking the present MSP, the head rotates around the pivot of the actuator 3. As a result, an offset occurs between the read and write head elements of the head. More precisely, a DC offset develops between positions 600R and 600W the read head element and the write head element, both tracking the MSP, respectively take radially with respect to the disk. The write head element writes the SSW pattern during the SSW process.

While the SSW process is proceeding in an intermediate or outer circumferential part, the SSW pattern is generated at a circumferential part outer than radial position 600R. The position data (POS-SSW) 150, if acquired in this state, is identical to the DC data about the SSW pattern in the past SSW process. Assume that the DC value is zero if measured while the read head element is tracking the MSP at radial position 600R. Then, radial position 600W at which to write the SSW pattern is an offset position 620. Therefore, the MSP position must be seek for a distance equivalent to the offset 620, in order to detect the DC value at radial position 600W.

The track seek at the tracking on the MSP is performed at the pitch of half a track, and is therefore repeated 2M times (about 20 times in the case of FIG. 7), thereby positioning the read head element at position 600W. While the read head element remains at position 600W, the DC value for the position data (POS-SSW). The read head element is moved back to position 600R again, and the SSW process is then performed. Consequently, the time of the SSW process increases. In view of this, the sinusoidal waveform is inferred, the phase is shifted by a value equivalent to the R/W offset, and the DC value for POS-SSW is inferred, thereby correcting the DC value.

As described above, the second target orbit generator 16 generates the second target position data 160. The second target position data 160 is the target correction value obtained by synthesizing a plurality of target track values. That is, it is the second target position data 160 for used in three correction processes that differ in objective as stated above.

The first correction process is a process of correcting the MSP switching time. If one MSP is switched to another, the first target track value is corrected to be used as a parallelism correction value after the MSM switching. A track correction value is determined as a synthesized waveform based on the result of multi-sync order DFT. The track correction value is updated at every MSP switching.

The second correction process is a process of correcting the low-order sync components. As is known in the art, any low-order sync component is not so much corrected at an inner circumferential part, and more corrected toward the outermost circumferential part. Therefore, in this embodiment, the low-order sync component is corrected at an intermediate circumferential part when the head reaches the cylinder designated beforehand, and the target value is updated every time the track seek is performed by a half-track distance.

In this case, the target value is updated as follows. The POS-SSW 150 is detected while the first and second target correction values remain valid. Every time the POS-SSW 150 is detected, the DFT coefficient is updated, thereby generating a low-order sync suppression value. The POS-SSW 150 is detected by head H1. Nonetheless, head H0, H2 or H3 may detect the POS-SSW 150. Alternatively, the DFT coefficient may be updated in accordance with the average of the POS-SSWs detected by heads H0 to H3.

The third correction process is designed to correct changes in the feed track pitch. In this process, the DC correction value for suppressing the feed track pitch is not corrected at any inner circumferential part, but corrected immediately after the SSW process is performed at the intermediate circumferential part and the head reaches a position where the POS-SSW can be completely detected even if no track seek is performed. The track pitch variation is approximated to a specific sinusoidal wave, through an adaptive updating of the DFT coefficient. The DFT coefficient is updated every time the track seek is performed every time the half-track seek is repeated a prescribed number of times. The mount in which DC is supplied is changed at every half-track seek, in accordance with the DFT coefficient of the sinusoidal wave.

The target DC correction value changed every time is predicted as value representing an advanced phase equivalent to the read/write offset. The advanced phase is updated at a specific boundary called “SSW process zone,” in a cycle different from the adaptive updating of the DFT coefficient. The advanced phase needs be updated only at such frequency as to preserve appropriate accuracy. It may be updated every time.

As has been described, the present embodiment can generate an ideal target-orbit component that is hard to generate through the target orbit correction using MSP only. More specifically, the embodiment can correct, by using pattern data actually acquired, the low-order synchronous residues that tend to increase at an outer circumferential part and cannot be compensated for by using only the data hitherto available. Further, the embodiment can be used to ensure the parallelism of the tracks at the time of MSP switching, reducing the rate of generating defects from the SSW-processed servo patterns.

Moreover, the embodiment can suppress the variation in the track pitch after the SSW process, which occur when two or more heads perform the bank write operation. Since these track pitch variation can be suppressed, the heads spaced from the MSP disk surfaces can perform the bank write operation at the same time. Hence, the MSP disk surfaces can be fewer than is required hitherto.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A disk storage apparatus comprising:
a head configured to read and write data;
a disk having disk surfaces on which a plurality of spiral servo patterns are recorded;
a controller configured to perform a servo write control for writing a plurality of radial servo patterns on each disk surface of the disk by using the spiral servo patterns,
wherein the controller comprises:
a servo controller configured to position the head above the spiral servo patterns by using first position information based on the spiral servo patterns;
a position information generator configured to generate second position information based on the radial servo patterns read by the head positioned above the spiral servo patterns; and
a processor configured to correct target position information for positioning the head based on the second position information by using the spiral servo patterns read by the head.

2. The disk storage apparatus of claim 1, wherein the controller comprises a first target position information generator configured to generate first target position information when the servo controller performs a control, positioning the head at a target position above the spiral servo patterns, and a second target position information generator configured to generate second target position information based on the second position information, and
the processor is configured to use the second target position information, thereby to correct the target position information if the first target position information is used as the target position information for controlling the position of the head.

3. The disk storage apparatus of claim 1, wherein each spiral servo pattern is recorded on the first disk surface of the disk; the head comprises a first head associated with the first disk surface of the disk and a second head associated with a second disk surface; and wherein the controller is configured to perform a servo write control, by using the spiral servo patterns read by the first head, causing the first and second heads to write the radial servo patterns on the first and second disk surfaces, respectively.

4. The disk storage apparatus of claim 3, wherein the position information generator is configured to read a signal reproduced based on the written radial servo patterns by the first head tracking one of the spiral servo patterns or the second head, and to generate the second position information that represents the positional deviation the head with respect to the radial servo patterns.

5. The disk storage apparatus of claim 2, wherein the second target position information generator is configure to generate, based on the second position information, second target position information for achieving rotation sync compensation for low-order suppression.

6. The disk storage apparatus of claim 2, wherein the second target position information generator is configure to generate, based on the second position information, second target position information for calculating a DC correction value for use in suppressing changes of the pitch of the servo tracks.

7. The disk storage apparatus of claim 1, further comprising:
a plurality of disks; and
a plurality of heads associated with the disk surfaces of the disks, respectively,
wherein the controller is configured to perform a servo write control with a bank write method in which the heads write the radial servo patterns on the disk surfaces of the disks at the same time.

8. The disk storage apparatus of claim 1, wherein the controller is configured to perform the servo write control with a self-servo write method.

9. The disk storage apparatus of claim 2, wherein each spiral servo pattern is recorded on the first disk surface of the disk; the head comprises a first head associated with the first disk surface of the disk and a second head associated with a second disk surface; and wherein the controller is configured to perform a servo write control, by using the spiral servo patterns read by the first head, causing the first and second heads to write the radial servo patterns on the first and second disk surfaces, respectively.

10. A method of writing servo patterns, for use in a disk storage apparatus having a head configured to read and write data and a disk having disk surfaces on which a plurality of spiral servo patterns are recorded, the method comprising:
positioning the head above the spiral servo patterns by using first position information based on the spiral servo patterns;
generating second position information based on the radial servo patterns read by the head positioned above the spiral servo patterns; and
correcting target position information for positioning the head based on the second position information by using the spiral servo patterns read by the head.

11. The method of claim 10, further comprising:
generating first target position information for positioning the head at a target position above the spiral servo patterns; and
generating second target position information based on the second position information,
wherein the second target position information is used to correct the target position information if the first target position information is used as the target position information for controlling the position of the head.

12. The method of claim 10, wherein each spiral servo pattern is recorded on the first disk surface of the disk; and the head comprises a first head associated with the first disk surface of the disk and a second head associated with a second disk surface, further comprising:
performing a servo write control, by using the spiral servo patterns read by the first head, causing the first and second heads to write the radial servo patterns on the first and second disk surfaces, respectively.

13. The method of claim 12, further comprising:
reading a signal reproduced based on the written radial servo patterns by the first head tracking one of the spiral servo patterns or the second head; and
generating the second position information that represents the positional deviation the head with respect to the radial servo patterns.

14. The method of claim 11, further comprising:
generating, based on the second position information, second target position information for achieving rotation sync compensation for low-order suppression.

15. The method of claim 11, further comprising:
generating, based on the second position information, second target position information for calculating a DC correction value for use in suppressing changes of the pitch of the servo tracks.

16. The method of claim 10, further comprising:
performing a servo write control with a bank write method in which the heads write the radial servo patterns on the disk surfaces of the disks at the same time.

17. The method of claim 10, further comprising:
performing the servo write control with a self-servo write method.

18. The method of claim 11, wherein each spiral servo pattern is recorded on the first disk surface of the disk; and the head comprises a first head associated with the first disk surface of the disk and a second head associated with a second disk surface, further comprising:
performing a servo write control, by using the spiral servo patterns read by the first head, causing the first and second heads to write the radial servo patterns on the first and second disk surfaces, respectively.
